(19) United States
(12) Patent Application Publication
(10) Pub. No.: US 2011/0238601 A1
(43) Pub. Date: Sep. 29, 2011

(54) Method for Ice Distribution

(76) Inventor: Talmadge B. Reed, JR., Lincolnton, GA (US)

(21) Appl. No.: 13/075,141

(22) Filed: Mar. 29, 2011

Related U.S. Application Data
(60) Provisional application No. 61/318,768, filed on Mar. 29, 2010.

(51) Int. Cl. G06Q 90/00

(52) U.S. Cl. 705/500

(57) ABSTRACT

The method is for distributing ice to the foodservice industry utilizing the existing foodservice infrastructure. This invention enables new markets and new revenue sources for the ice selling vendor based on utilizing the foodservice distribution infrastructure. This method allows the ice manufacturer to do business on a national or global scale.

### CROSS-REFERENCE TO RELATED APPLICATIONS

This application claims the benefit of priority to U.S. Provisional Patent Application No. 61/318,768 filed on Mar. 29, 2010 by the present inventor, the contents of which are incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates in general to a method for distributing ice-filled bags or packaged ice to the foodservice industry. The foodservice industry includes foodservice distributors which distribute the packaged ice to end users such as, for example, restaurants, cafeterias, institutions, hospitals, or anywhere a meal is prepared away from home.

2. Background of the Invention

Packaged ice is sold at retail establishments such as supermarkets, mass merchants and convenience stores. It is used to keep food and beverages at sufficiently cold or comfortable temperatures particularly when refrigeration is not available. As a minimum, a packaged ice manufacturer must have a manufacturing plant and a distribution infrastructure. Typically, the ice manufacturer delivers packaged ice in large quantities directly to the local customer. It is neither cost effective to deliver smaller quantities to customers nor customers outside the local area. Because of these high costs associated with building a manufacturing plant and the limitations of a local distribution infrastructure, the ice manufacturer is geographically limited to a local retail market. The ice manufacturer cannot compete successfully for customers outside his local geographical area.

A foodservice distributor functions as an intermediary between food manufacturers and the foodservice operator (usually a chef, foodservice director, food & beverage manager, and independent food preparation businesses operator owners.) Foodservice distributors procure pallets and bulk inventory quantities that are broken down to case and sometimes unit quantities for the foodservice operator. Foodservice distributors such as, for example, Sysco and U.S. Foodservice; have sophisticated distribution infrastructures. From grower to consumer, food often changes hands a dozen times or more, moving along a food supply chain or infrastructure that links producers, packers, shippers, food manufacturers, wholesale distributors, food retailers, and consumers.

These infrastructures distribute food and related products to thousands of customers throughout the United States, including restaurants, healthcare facilities, lodging establishments, cafeterias, schools, and colleges. There is a need for a business method to allow the ice manufacturer to distribute his packaged ice to customers throughout the United States by utilizing the large-scale distribution infrastructures of foodservice distributors.

### SUMMARY OF THE INVENTION

This invention pertains to a method, using the foodservice distribution infrastructure, to allow an ice manufacturer to sell his packaged ice to foodservice distributors who then distribute the packaged ice to remote customers far away from the ice manufacturing plant. The ice manufacturer is known as the ice selling vendor in this method. The invention utilizes the existing foodservice distribution infrastructure of foodservice distributors such as, for example, Sysco and U.S. Foodservice. If the ice selling vendor does not have the ability to fulfill an order, the ice selling vendor can contract with a third party ice vendor to fulfill the order using the business method described in this invention. This invention enables new markets and new revenue sources for the ice selling vendor based on utilizing the foodservice distribution infrastructure. The ice manufacturer can do business on a national or global scale.

### BRIEF DESCRIPTION OF THE DRAWINGS

Referring now to the drawings in which like reference numbers represent corresponding parts throughout:

FIG. 1 is a perspective view of an empty container in accordance with the preferred embodiment of the present invention.

FIG. 2 is a perspective view of a container containing the packages ice bags in accordance with the preferred embodiment of the present invention.

FIG. 3 is a perspective view of a pallet supporting the packaged ice containers in accordance with the preferred embodiment of the present invention.

FIG. 4 is a flow chart showing a method for distributing packaged ice in accordance with the preferred embodiment of the present invention.

### DETAILED DESCRIPTION OF THE INVENTION

The present invention will now be described more fully hereinafter, in which preferred embodiments of the invention are shown. This invention may; however, be embodied in different forms and should not be construed as limited to the embodiments set forth herein. Rather, these embodiments are provided so that this disclosure will be thorough and complete, and will fully convey the scope of the invention to those skilled in the art.

A method for distributing ice in accordance with the present invention may include some or all of the following steps: A) receiving an order for packaged ice from a foodservice distributor; B) packaging ice in plastic bags, wherein the each bag typically contains 5 pounds or 20 pounds of ice; C) inserting 2 plastic bags of ice into a container, wherein the container is typically an adequately sized cardboard box; D) closing and sealing the container; E) palletizing the containerized packaged ice as necessary; F) delivering the pallets of containerized packaged ice to the foodservice distributor's warehouse; and G) collecting revenue from the foodservice distributor for the ice pallets.

### 1. Parties To A Transaction

The present invention provides a method for the distribution of packaged ice using the foodservice distribution infrastructure. The ice manufacturer typically has an ice manufacturing plant to make ice. The ice is packaged in plastic bags and sold in bulk. Here, the ice manufacturer acts as an ice selling vendor, selling ice to the foodservice distributor. The foodservice distributor sells and distributes the packages ice end users such as, for example, restaurants, cafeterias, institutions, hospitals. If the ice manufacturer or ice selling vendor does not have the plant capacity to produce an order of packaged ice or it is not profitable to fulfill the order, the ice selling vendor can enter a contract with a third party ice vendor to fulfill the order. For example, the third party ice vendor may be an ice manufacturer closer to the foodservice distributor's warehouse. Also, the third party ice vendor may have a larger ice manufacturing plant and has the ability to fulfill the order quicker and with less production costs.

### 2. Components

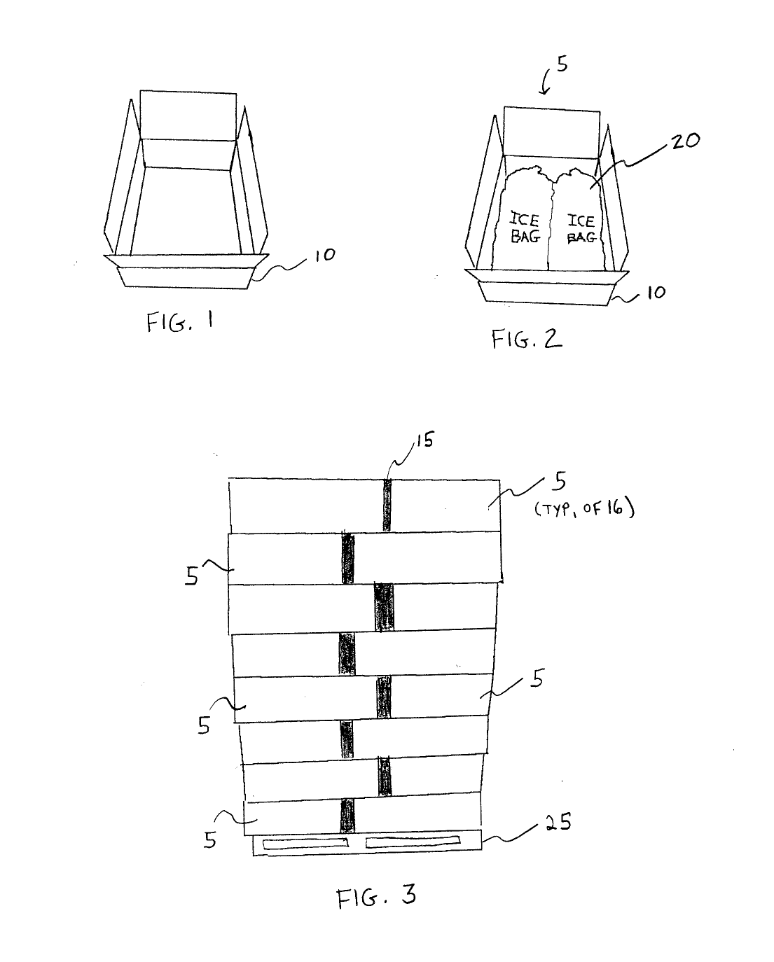

As shown in FIG. 1, an exemplary embodiment of the invention includes a container 10. The container 10 may be a typical cardboard box sized to hold to bags of packaged ice 20 as shown in FIG. 2. The size, shape, and material composition of the container 10 are immaterial to this method of distributing packaged ice. Other suitable materials may include wood, plastic, metal, or other materials suitable for forming containers. The container may be lined with a thermal insulating material to keep the ice from melting or the container walls may be un-insulated or bare. The ice container 5 may be taped, glued, or sealed closed by any common technique.

As shown in FIG. 2, there are two (2) bags of packaged ice 20 placed inside the container 10. Each bag of packaged ice 20 typically contains 5 pounds or 20 pounds of ice; however, the amount of ice that a bag holds is immaterial. Other size bags of packaged ice 20 are suitable. As shown in FIG. 2 and FIG. 3, the ice containers 5 may be stacked on pallets 25 to facilitate shipping and delivery. The ice containers 5 may have small gaps or spaces 15 between each other while stacked on the pallet 25.

Packaged ice is delivered to the foodservice distributor's warehouse where the ice is stored below freezing temperature while awaiting for distribution to end users such as, for example, restaurants, cafeterias, institutions, or hospitals. The foodservice distributor may be Sysco or U.S. Foodservice, but and foodservice distributor with an adequate distribution infrastructure is adequate.

### 3. System Operation

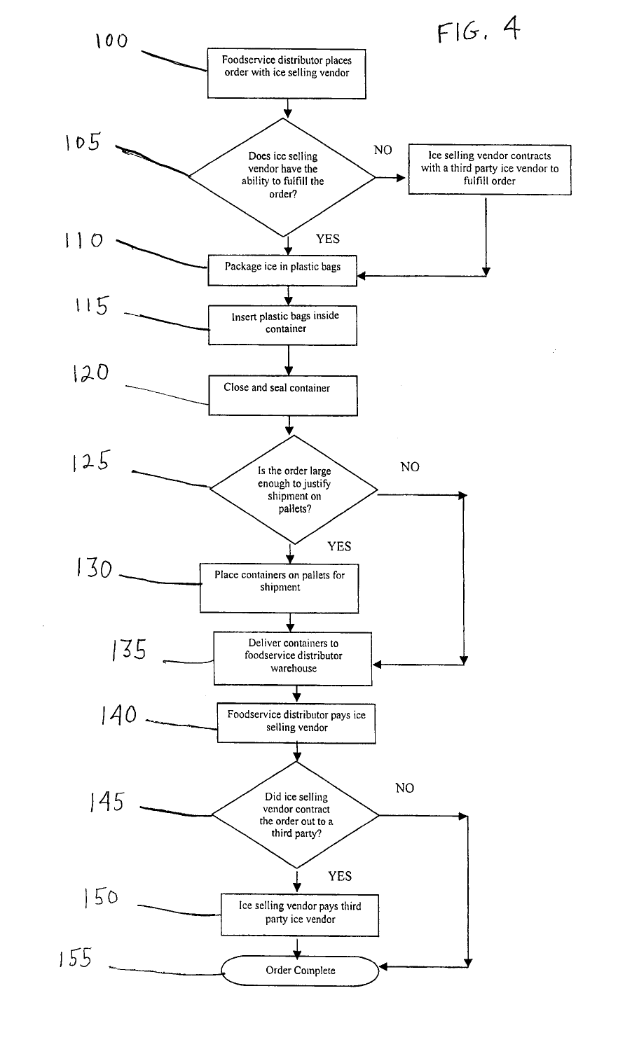

As shown in FIG. 4 an exemplary, general overview of the flow of information through distribution system 95 occurs as follows: (i) the foodservice distributor places an order for packaged ice with ice selling vendor in step 100; (ii) the ice selling vendor confirms that the order can be fulfilled in step 105 (if no, the ice selling vendor contracts with a third party ice vendor to fulfill order in step 108); (iii) the vendor (whichever vendor fulfills the order) packages the ice in plastic bags in step 110; (iv.) the vendor inserts the plastic bags inside the container in step 115; (v) the vendor closes and seals the container in step 120; (vi) the vendor confirms that the order is large enough to justify shipment on pallets in step 125 and if so, the containers are placed on pallets for shipment in step 130 (if not, the vendor does not use pallets, the containers are shipped independently); (vii) the vendor delivers the containers (either on pallets or shipped independently) to the foodservice distributor's warehouse in step 135; (viii) foodservice distributor pays ice selling vendor in step 140; (ix) ice selling vendor confirms whether or not the order was contracted out to a third party ice vendor in step 145 (if yes, ice selling vendor pays third party ice vendor in step 150); (x) order is complete in step 155.

The following examples are illustrative of some possible scenarios.

### EXAMPLE 1

An ice manufacturer (ice selling vendor) in Lincolnton, Ga. receives a bulk order for bulk ice from Sysco in Columbia, S.C. The ice selling vendor confirms that the order can be fulfilled, packages the ice in plastic bags, and inserts the bags inside a container. The ice selling vendor confirms that the order is large enough to justify shipment on pallets, so the containers are stacked on pallets. The ice selling vendor delivers the pallets to Sysco's warehouse in Columbia, S.C. Sysco pays ice selling vendor in Lincolnton, Ga. for the ice shipment. The order is complete.

### EXAMPLE 2

An ice manufacturer (ice selling vendor) in Lincolnton, Ga. receives a bulk order for bulk ice from Sysco in Los Angeles, Calif. Due to the long distance, the ice selling vendor confirms that the order is not feasible to fulfill from his ice manufacturing facility in Lincolnton, Ga. The ice selling vendor locates an ice manufacturer (third party ice vendor) in Anaheim, Calif. which is relatively close to Sysco in Los Angeles, Calif. The ice selling vendor Lincolnton, Ga. contracts (legal binding contract) with the third party ice vendor in Anaheim, Calif. to fulfill the order. The third party ice vendor in Anaheim, Calif. packages the ice in plastic bags, and inserts the bags inside a container. The third party ice vendor confirms that the order is large enough to justify shipment on pallets, so the containers are stacked on pallets. The third party ice vendor delivers the pallets to Sysco's warehouse in Los Angeles, Calif. Sysco pays ice selling vendor in Lincolnton, Ga. for the ice shipment.

The ice selling vendor in Lincolnton, Ga. confirms the order was contracted out to a third party ice vendor in Anaheim, Calif. and pays third party ice vendor per the contract. The order is complete.

While the above description contains much specificity, these should not be construed as limitations on the scope of the invention, but rather as exemplification of preferred embodiments. Numerous other variations of the present invention are possible, and it is not intended herein to mention all of the possible equivalent forms or ramifications of this invention.

1. A method for selling or distributing ice between an ice selling vendor and a foodservice distributor, the method comprising the steps of: (a) a foodservice distributor placing an order for packaged ice with an ice selling vendor; (b) the ice selling vendor confirming that the order can be fulfilled; (c) if the ice selling vendor cannot fulfill the order, the ice selling vendor contracts with a third party ice vendor to fulfill the order; (d) the vendor packages the ice in plastic bags; (e) the vendor inserts the plastic bags inside the container; (f) the vendor closes and seals the container; (g) the vendor confirms that the order is large enough to justify shipment on pallets; (h) if the vendor confirms that the order is not large enough to justify shipment on pallets, the vendor does not use pallets, the containers are shipped independently; (i) the vendor delivers the containers to foodservice distributor warehouse; (j) foodservice distributor pays ice selling vendor; (k) ice selling vendor confirms whether or not the order was contracted out to a third party ice vendor; (l) if ice selling vendor confirms the order was contracted out to a third party ice vendor, ice selling vendor pays third party ice vendor; and (m) order is complete.

2. The method of claim 1, wherein the steps are performed sequentially.

3. The method of claim 1, wherein the ice selling vendor manufactures the ice.

4. The method of claim 1, wherein the containers are filled with two bags of ice.

5. The method of claim 1, wherein the temperature inside the foodservice distributor's warehouse is near or below freezing.

6. The method of claim 1, wherein the ice is shipped by means of the foodservice distribution infrastructure.

7. A method of distributing ice, comprising: providing ice in plastic bags; providing containers; providing pallets; completing an order of said ice by first having a foodservice distributor place an order for packaged ice with an ice selling vendor;
verifying that the order can be fulfilled by ice selling vendor, wherein when said order is verified it cannot be fulfilled, the ice selling vendor contracts with a third party ice vendor to fulfill the order; packaging the ice in plastic bags; inserting said bags inside the container; closing the container; sealing the container; verifying that the order is large enough to justify shipment on pallets, wherein when said order is not large enough to justify shipment on pallets, vendor ships the containers without pallets; delivering the containers to the foodservice distributor's warehouse; receiving payment from the foodservice vendor for the order of ice; verifying that the ice selling vendor contracted the order out to a third party and paying third party ice vendor for the order, wherein when order was not contracted out to a third party the ice selling vendor does not pay anyone.

8. The method of claim 6, wherein the steps are performed sequentially.

9. The method of claim 6, wherein the ice selling vendor manufactures the ice.

10. The method of claim 6, wherein the containers are filled with two bags of ice.

11. The method of claim 6, wherein the temperature inside the foodservice distributor's warehouse is near or below freezing.

12. The method of claim 6, wherein the ice is shipped by means of the foodservice distribution infrastructure.

13. A method of distributing ice between an ice selling vendor and a foodservice distributor, comprising: providing ice; providing containers; and providing a means for utilizing the foodservice distribution infrastructure wherein the ice selling vendor collects revenue for ice from customers throughout the globe.

14. The method of claim 11, wherein the ice is packaged in bags.

15. The method of claim 11, wherein the ice selling vendor manufactures the ice.

16. The method of claim 11, wherein the containers are filled with bags of ice.

17. The method of claim 11, wherein the temperature inside the foodservice distributor's warehouse is near freezing.
